(19) United States
(12) Patent Application Publication
(10) Pub. No.: US 2025/0172331 A1
(43) Pub. Date: May 29, 2025

(54) REFRIGERATOR

(71) Applicant: LG ELECTRONICS INC., Seoul (KR)

(72) Inventors: Seongwon GWON, Seoul (KR); Jinho CHANG, Seoul (KR); Heejun LEE, Seoul (KR)

(21) Appl. No.: 18/961,683

(22) Filed: Nov. 27, 2024

(30) Foreign Application Priority Data
Nov. 27, 2023 (KR) 10-2023-0166482

(51) Int. Cl. F25D 23/02

(52) U.S. Cl. CPC F25D 23/028; F25D 2323/02

(57) ABSTRACT

A refrigerator includes: a cabinet having a storage space; a first door opening or closing the storage space and having an opening; a second door opening or closing the opening and rotatable with respect to the first door; a locking device for causing the first door and the second door to be in a locked or unlocked state in a state where the second door is closed; and a door opening device for automatically opening the second door, wherein when the door opening device is actuated, the door opening device opens the second door after moving the locking device to an unlocked position.

### CROSS-REFERENCE TO RELATED PATENT APPLICATIONS

This application is claims priority to Korean Patent Application No. 10-2023-0166482, filed Nov. 27, 2023, whose entire disclosures are hereby incorporated by reference.

### FIELD

The present disclosure relates to a refrigerator.

### BACKGROUND

In general, a refrigerator is a household appliance that allows food to be stored at a low temperature in an internal storage compartment shielded by a door.

The storage compartment is surrounded by insulating walls, such that the interior of the storage compartment is maintained at a lower temperature than the outside temperature. Depending on the temperature band of the storage chamber, the storage chamber may be referred to as a refrigerator or a freezer.

In order to put an object into or take it out of the storage compartment, the user opens a door. Generally, the door is rotatably mounted on the cabinet, and a gasket is provided between the door and the cabinet. Thus, when the door is closed, the gasket fits tightly between the door and the cabinet to prevent cold air from leaking from the storage compartment. As the tightness of such the gasket is increased, the effectiveness of preventing cold air leakage may be increased.

To increase the sealing force of the gasket, a magnet may be provided inside the gasket. However, when the sealing force of the gasket is increased, a large force is required to open the door.

Therefore, recently, a refrigerator with an automatic door opening function has been provided.

In the prior art, Korean Public Patent Publication No. 10-2018-0119027, a refrigerator is disclosed.

The refrigerator of the prior art includes a cabinet having at least one storage space inside, a door disposed on one side of the cabinet for opening and closing the storage space, and a door opening device for moving the door so that the storage space is opened by a driving force of a motor.

The door may include an inner door that fits against a front side of the cabinet, and an outer door that is disposed against a front side of the inner door.

The door opener may be provided on the cabinet, and may push the inner door to open the inner door.

However, in the prior art, when the inner door is opened, the outer door is opened together with the inner door, which has the disadvantage of not automatically opening the outer door.

Furthermore, in the prior art, since the cabinet is provided with a door opening device, if it is desired to open the outer door using the door opening device, the length of the door opening device is increased and the structure is complicated in order to push the outer door without interfering with the inner door.

### SUMMARY

One embodiment provides a refrigerator including a door having a first door and a second door, wherein an automatic opening of the second door positioned outside the first door is possible.

Optionally or additionally, one embodiment provides a refrigerator including a first door and a second door, wherein an automatic opening of the second door positioned outside the first door, while still allowing a manual opening of the second door.

Optionally or additionally, one embodiment provides a refrigerator that the first door and the second door remain engaged when the first door is opened.

A refrigerator according to one aspect may comprise a cabinet having a storage space. The refrigerator may further comprise a door opening or closing at least a portion of the storage space. The door may comprise a first door having an opening. The first door may open or close at least a portion of the storage space.

The door may further comprise a second door, opening or closing the opening and rotatable with respect to the first door.

The refrigerator may further comprise a locking device that allows the first door and the second door to be in a locked or unlocked state when the second door is closed. To move from the locked state to the unlocked state, the locking device may be movable from a locked position to an unlocked position.

The refrigerator may further comprise a door opening device for automatically opening the second door.

When the door opening device is actuated, the door opening device may open the second door after moving the locking device to the unlocked position.

In a non-operational state of the door opening device, the locking device may be manually moved to the unlocked position by user operation.

The door opening device and the locking device may be provided on the second door.

The door opening device may comprise a drive part. The door opening device may further comprise a first movement member that is powered by the drive part. The door opening device may further comprise a door opening portion.

When the drive part is actuated to open the second door, the first movement member may move in a first direction. In the process of the first movement member moving in the first direction, the first movement member may actuate the locking device.

The door opening device may further comprise a second movement member that transmits a movement force of the first movement member to the locking device.

Upon movement of the first movement member in the first direction, the second movement member may curvilinearly move in a second direction intersecting the first direction.

When the first movement member is moved a first distance from the initial position, the locking device may be actuated. When the first movement member is moved a second distance from the first position, the door opening may begin to operate. The second distance may be greater than the first distance.

When the first movement member is moved from the first position by a third distance, The door opening portion may be moved to a door opening position. The third distance may be greater than the second distance.

The door opening portion may comprise a pusher, actuated by a movement force of the first movement member to press the first door.

The door opening portion may further comprise a first transmission portion movable by the first movement member. The door opening portion may further comprise a second transmission portion movable by the first transmission portion. The second transmission portion may be rotatably connected to the first transmission portion.

The pusher may be connected to the second transmission portion. The pusher may be rotatably connected to the second transmission portion.

The first transmission portion may be linearly movable. The second transmission portion and the pusher may be rotatably movable.

When the first movement member is moved a first distance from a first position which is an initial position, the locking device may be actuated. When the first movement member is moved from the first position to a second distance or more, a movement force of the first movement member may be transmitted to the first transmission portion.

The door opening portion may comprise a first magnetic unit provided on the first door. The door opening portion may further comprise a second magnetic unit provided in the second door. The second magnetic unit may be movable together with the first movement member.

The first magnetic unit may include a first magnet having a first pole, and a second magnet having a second pole opposite to the first pole. The second magnetic unit may include a third magnet having the first pole and a fourth magnet having the second pole.

For opening of the second door, the third magnet may be movable in a direction closer to the first magnet.

In a closed state of the second door, the first magnet and the second magnet may be arranged in a Y-axis direction, which is the direction of arrangement of the first door and the second door. The third magnet and the fourth magnet may be arranged in the Y-axis direction. The third magnet may be positioned closer to the first magnet than to the fourth magnet.

In a state where the second door is closed, the first magnet and the second magnet may be arranged in an X-axis direction intersecting with an arrangement direction of the first door and the second door. The third magnet and the fourth magnet may be arranged in the X-axis direction. The fourth magnet may be positioned closer to the first magnet than to the third magnet.

The refrigerator may further comprise a sensor portion for detecting an input of an opening command of the second door, and a controller for controlling the door opening device.

The controller may control the door opening device such that, when the sensor part detects input of an opening command of the second door, the first door and the second door are in an unlocked state and the second door is opened.

A refrigerator, according to another aspect, may comprise: a cabinet having a storage space; and a door for opening or closing at least a portion of the storage space.

The door may comprise: a first door rotatably connected to the cabinet; a second door rotatable with respect to the first door. The door may include a locking device for locking the first door and the second door in a locked or unlocked state when the second door is closed; and a door opening device for automatically opening the second door.

In a locked position of the locking device, the locking device is manually operable by a user and automatically operable by the door opening device.

The storage space may include a refrigeration chamber, and a freezer chamber positioned below the refrigeration chamber. The first door may open or close the refrigeration chamber.

The door opening device and the locking device may be located on a lower side of the second door.

The door opening device may comprise a door opening portion. An operation time of the locking device may be set differently from an operation time of the door opening portion.

The door opening device may include a drive part, and a first movement member powered by the drive part. The door opening portion may be connected to the first movement member.

When the drive part is actuated, the first movement member may actuate the door opening portion after the locking device is moved to an unlocked position by the first movement member.

### BRIEF DESCRIPTION OF THE DRAWINGS

FIG. 1 is a perspective view of a refrigerator according to one embodiment of the present invention.

FIG. 2 is a drawing showing a second door open in a refrigerator chamber door according to one embodiment of the present invention.

FIG. 3 is a drawing showing a refrigeration chamber door and a freezer chamber door open, according to one embodiment of the present invention.

FIG. 4 is a perspective view showing the first door and the second door with the lock in the locked position, according to one embodiment of the present invention.

FIG. 5 is a perspective view showing a lower portion of the first door, according to one embodiment of the present invention.

FIG. 6 is a drawing showing a door opening device installed on a second door according to one embodiment of the present invention.

FIGS. 7A and 7B are perspective views of a door opening device according to one embodiment of the present invention.

FIG. 8A is a perspective view of a first movement member according to one embodiment of the present invention from a first side.

FIG. 8B is a perspective view of a first movement member according to one embodiment of the present invention from a second side.

FIG. 9A is a perspective view of a first transmission member according to one embodiment of the present invention from a first side.

FIG. 9B is a perspective view of a first transmission member according to one embodiment of the present invention from a second side.

FIG. 10A is a drawing showing the position of the second extension of the first movement member and the contact protrusion of the first transmission member in a first position.

FIG. 10B is a drawing showing the second portion of the first movement member in contact with the contact protrusion of the first transmission member during the opening process of the second door.

FIG. 11A is a perspective view of a door opening according to one embodiment of the present invention.

FIG. 11B is a perspective view showing a state in which the pusher and the second transmission member are connected according to one embodiment of the present invention.

FIG. 12A is a perspective view of the second transfer member according to one embodiment of the present invention.

FIG. 12B is a perspective view of the lock according to one embodiment of the present invention.

FIG. 13 is a control block diagram of a refrigerator, according to one embodiment of the present invention.

FIG. 14 is a flow diagram illustrating the operation of the door opening device and the locking device step by step according to a travel distance of the first movement member.

FIGS. 15A and 15B are drawings illustrating the door opening device and locking device in a first position of the first movement member.

FIGS. 16A and 16B are drawings illustrating the door opening device and the locking device when the first movement member has moved a second distance.

FIGS. 17A and 17B are drawings showing a door opening device and a locking device with the first movement member moved to a second position.

FIG. 18 is a drawing showing the second door in a state in which the opening of the second door is complete.

FIG. 19A is a drawing showing the door opening device and locking device in a first position of the first movement member,

FIG. 19B is a drawing showing the door opening device and locking device in a second position of the first movement member, in accordance with another embodiment of the present invention.

### DETAILED DESCRIPTION THE INVENTION

Hereinafter, some embodiments of the present invention will be described in detail with reference to the exemplary drawings. It should be noted that in assigning reference numerals to the components in each drawing, the same components are intended to have the same numerals as much as possible, even if they are shown in different drawings. In addition, in describing embodiments of the present disclosure, specific descriptions of related disclosed configurations or features are omitted where it is determined that such detailed description would impede an understanding of the embodiments of the present disclosure.

Further, in describing components of embodiments of the present disclosure, terms such as first, second, A, B, (a), (b), and the like may be used. Such terms are intended only to distinguish one component from another, and the nature, sequence, or order of such components is not limited by such terms. When a component is described as being “connected,” “coupled,” or “connected” to another component, it is to be understood that the component may be directly connected or connected to the other component, but that another component may be “connected,” “coupled,” or “connected” between each component.

As used herein, the front side of the second door is the side forming the front appearance of the refrigerator door, and the back side is the side facing the first door.

The front of the first door is the side forming the front exterior of the first door and facing the rear of the second door. The rear of the first door is a side facing a cabinet or storage space.

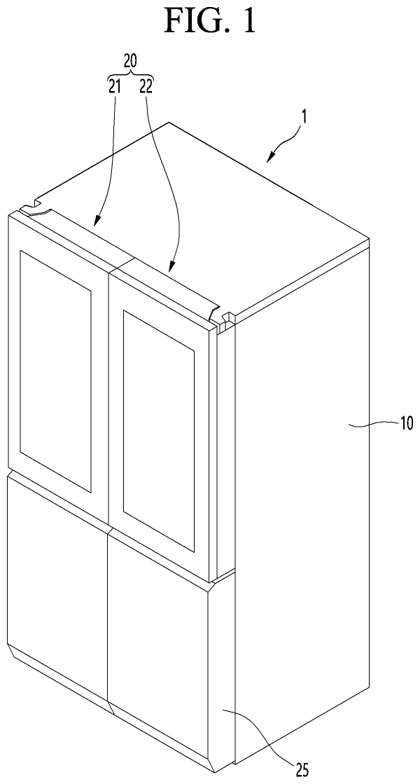

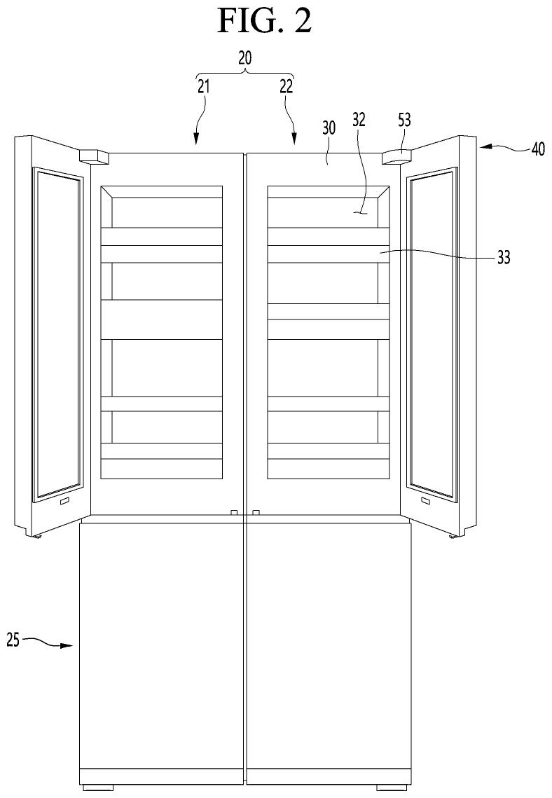

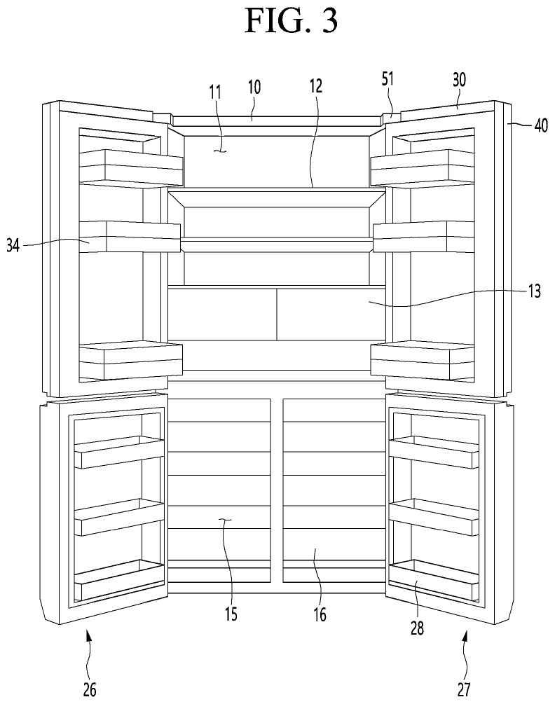

FIG. 1 is a perspective view of a refrigerator according to one embodiment of the present invention, and FIG. 2 is a drawing showing the second door open in a refrigerator chamber door according to one embodiment of the present invention. FIG. 3 is a drawing showing a refrigeration chamber door and a freezer chamber door open, according to one embodiment of the present invention.

Referring to FIGS. 1 to 3, a refrigerator 1 according to one embodiment of the present invention may include a cabinet 10 forming a storage space, and a refrigerator door opening and closing the storage space.

The storage space may include, for example, a refrigeration chamber 11 and a freezer chamber 15. Although not limitingly, the refrigeration chamber 11 may be located above the freezer chamber 15. Depending on the shape of the refrigerator, it is possible for the freezer chamber 15 and the refrigeration chamber 11 to be arranged side by side, and it is possible for the freezer chamber 15 to be located above the refrigeration chamber 11.

The refrigerator door may comprise a refrigerator chamber door 20 for opening and closing the refrigerator chamber t 11, and a freezer chamber door 25 for opening and closing the freezer chamber 15.

The refrigeration chamber door 20 may include, for example, a pair of doors 21 and 22 disposed side by side, i.e., the refrigeration chamber door 20 may include a first refrigeration chamber door 21 and a second refrigeration chamber door 22 disposed side by side. The first refrigeration chamber door 21 may open or close a portion of the refrigeration chamber 11, and the second refrigeration chamber door 22 may open or close the other portion of the refrigeration chamber 11.

The freezer chamber door 25 may comprise, for example, a pair of doors 26 and 27 disposed left and right, i.e., the freezer chamber door 25 may comprise a first freezer chamber door 26 and a second freezer chamber door 27 disposed left and right. The first freezer chamber door 26 may open or close a portion of the freezer chamber 15, and the second freezer chamber door 27 may open or close the other portion of the freezer chamber 15. Alternatively, the freezer chamber 15 may be partitioned left and right or up and down, the first freezer chamber door 26 may open or close one partitioned space, and the second freezer chamber door 27 may open or close the other partitioned space.

It should be noted that there is no limit to the number and arrangement of the refrigeration chamber doors 20 and the freezer chamber doors 25 herein. For example, it is possible for the storage space to comprise only a refrigeration chamber. Alternatively, a single refrigeration chamber door 20 may open or close the refrigeration chamber.

At least one of the first and second refrigeration chamber doors 26 and 27 may include a first door 30 that opens or closes the refrigeration chamber 11, and a second door 40 that is pivotable with respect to the first door 30.

In FIG. 3, it is shown, for example, that each of the first and second refrigeration chamber doors 21 and 22 includes the first door 30 and the second door 40.

The first door 30 may be rotatably connected to the cabinet 10 by a first hinge 51. The second door 40 may be rotatably connected to the first door 30 by a second hinge 53.

The first door 30 may comprise an opening 32. The second door 40 may open or close the opening 32. The opening 32 may be in communication with the refrigeration chamber 11.

The second door 40 may cover the opening 32 from a front of the first door 30. Alternatively, at least a portion of the second door 40 may be received in the opening 32 and cover the opening 32.

The first door 30 may be referred to as an interior door or main door, and the second door 40 may be referred to as an exterior door or sub-door.

The first door 30 may comprise one or more baskets 33 and 34. The baskets 33 and 34 may be mounted on a rear surface of the first door 30, or may be mounted on a surface forming the opening 32.

At least one of the first and second freezer doors 26 and 27 may comprise a basket 28. FIG. 2 illustrates, for example, each of the first and second freezer doors 26 and 27 being provided with a basket 28.

The second door 40 may comprise a panel assembly. The panel assembly may include one or more panels formed of a glass material or a material enabling light transmission. When a lighting unit provided in the refrigerator by the panel assembly is turned on, it may be possible to see into the storage space with the second door 40 closed, or to see an inside of the first door 30.

Meanwhile, the refrigeration chamber 11 may be equipped with one or more shelves 12. The refrigeration chamber 11 may be provided with one or more slidably withdrawable drawers 13. The freezer chamber 15 may be provided with one or more slidably withdrawable drawers 16. Of course, the shelves 12 or drawers 13 and 16 may be omitted in optional configurations.

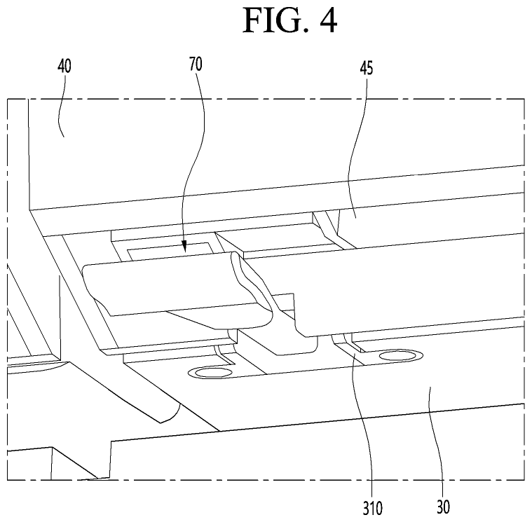

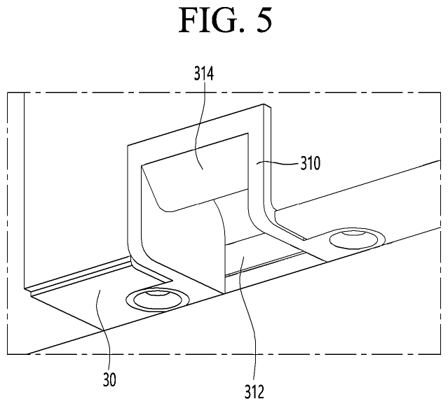

FIG. 4 is a perspective view showing the first door and the second door with the locking device in the locked position according to one embodiment of the present invention, and FIG. 5 is a perspective view showing a lower portion of the first door according to one embodiment of the present invention.

Referring to FIGS. 1 to 5, the first door 30 may be opened manually or automatically. In case of automatically opening the first door 30, a main opening device for opening the first door 30 may be provided on the first door 30 or the cabinet 10, although not shown. It is to be appreciated that the location or structure of the main opening device for opening the first door 30 may be subject to various techniques previously disclosed by the applicant of the present application. That is, it is possible for the first door 30 and the second door 40 to rotate together as the first door 30 is opened by the main opening device.

With the first door 30 closed, the second door 40 may be opened. In a state where the second door 40 is closed, the first door 30 may be opened. In this case, it is necessary to prevent the second door 40 from being rotated with respect to the first door 30 upon opening of the first door 30.

Thus, in this embodiment, the refrigeration chamber door 20 may further comprise a locking device 70 that allows the first door 30 and the second door 40 to remain locked or unlocked.

The locking device 70 may be moveable from a locked position to an unlocked position. The locking device 70 may return from the unlocked position to the locked position.

The locking device 70 may be manually operated by a user. Additionally, the locking device 70 may be automatically operated by a door opening device, as will be described later.

In one example, when manual opening of the second door 40 is required, a user may manipulate the locking device 70 to move the locking device 70 from a locked position to an unlocked position. When the locking device 70 is moved to the unlocked position, the second door 40 and the first door 30 may be in an unlocked state.

The locking device 70 may be movably provided on the second door 40. The second door 40 may be provided with a handle 45. The handle 45 may be provided in a recessed form on one side of the second door 40. For example, the handle 45 may be provided on a lower side of the second door 40.

The locking device 70 may be provided on a lower side of the second door 40. The locking device 70 may be located on the outer side of the handle 45. Alternatively, the locking device 70 may be located within a recessed space formed by the handle 45.

In the locked position of the locking device 70, the first door 30 and the second door 40 may be in the locked state. In this state, when a user pulls the handle 45, the first door 30 and the second door 40 may be rotated together.

In the unlocked state of the second door 40 and the first door 30, when the user pulls the handle 45, the second door 40 may be rotated in a state where the first door 30 is closed.

The first door 30 may be provided with a catching portion 310 for catching the locking device 70. The catching portion 310 may be integrally formed with or coupled to a member forming an exterior of the first door 30. For example, the catching portion 310 may be located on a lower side of the first door 30.

The catching portion 310 may form a space 312 for receiving a portion of the locking device 70. The catching portion 310 may include a catching wall 314 for catching a portion of the locking device 70 positioned in the space 312. A front surface of the catching wall 314 may comprise an inclined surface. In the process of the second door 40 being opened and then closed, the locking device 70 can be easily moved into the space 312 by moving along the slope.

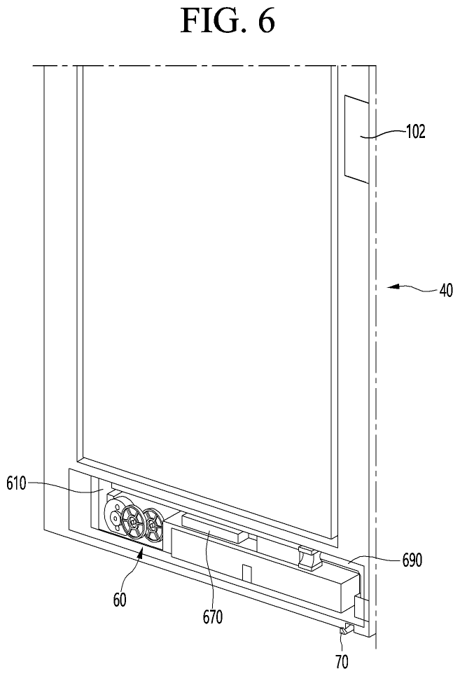

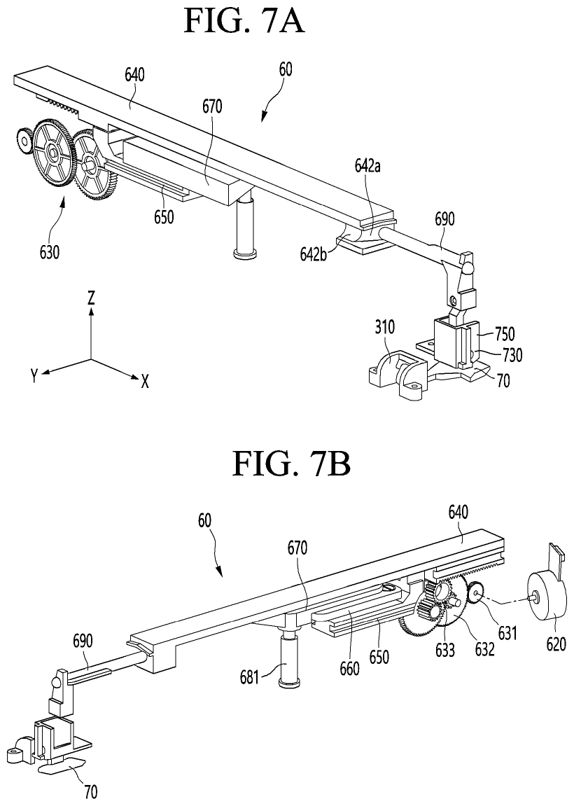

FIG. 6 is a drawing illustrating a door opening device installed on a second door according to one embodiment of the present invention. FIG. 7 is a perspective view of a door opening device according to one embodiment of the present invention. In FIG. 7, the casing of the door opening device is shown removed, in one example.

Referring to FIGS. 6 and 7, the door opening device 60 of this embodiment may be installed on the second door 40. The door opening device 60 may be operable to automatically open the second door 40. During operation of the door opening device 60, the locking device 70 may be moved to the unlocked position by the door opening device 60.

In order for the door opening device 60 to operate the locking device 70, the door opening device 60 may be disposed in a position adjacent to the locking device 70. For example, the door opening device 60 may be installed on a lower side of the second door 40.

In this embodiment, the locking device 70 may be a separate configuration from the door opening device 60 or may be an integral part of the door opening device 60.

The second door 40 may further comprise a sensor portion 102. The sensor portion 102 may detect input of a door opening command for opening the second door 40. The sensor portion 102 may be a touch sensor for detecting a touch of the front surface of the second door 40 by a user, or a knock sensor for detecting a plurality of knocks applied to the front surface of the second door 40. The sensor portion 102 may be a capacitive sensor, a vibration sensor, or a sound wave sensor. Alternatively, the sensor portion 102 may include a mechanical switch or may include a switch actuated by pressure.

As another example, the sensor portion 102 may be provided on the cabinet 10, or may be provided on the first door 30, or may be provided on the freezer chamber door 25.

The door opening device 60 may further comprise a drive part 620. The drive part may comprise a motor. The motor may be rotatable in both directions, for example.

The door opening device 60 may further comprise a case 610. The case 610 may be installed on the second door 40. The case 610 may support the components comprising the door opening device 60 or may hold the components in place.

In one example, the drive part 620 may be installed in the case 610.

The door opening device 60 may further comprise a transmission unit 630 that transmits power to the drive part 620. The transmission unit 630 may include, for example, a plurality of gears. Each of the plurality of gears may be rotatably supported on the case 610.

In one example, the plurality of gears may include a driving gear 631 connected to the drive part 620. The plurality of gears may include the driven gear 633.

The driven gear 633 may be directly connected to the driving gear 631 or may be connected to the driving gear 631 by one or more intermediate gears 632. It will be appreciated that there is no limit to the number of gears in the present invention.

The door opening device 60 may further comprise a first movement member 640, which is powered by the drive part 620.

The first movement member 640 may be connected to the transmission unit 630. The first movement member 640 may be, for example, a linearly moving rack. The first member 640 may, for example, engage with the driven gear 633.

In the process of automatic opening of the second door 40, the first movement member 640 may move from a first position which is an initial position to second position which is a final position.

After completion of opening of the second door 40, the first movement member 640 may return from the second position to the first position.

The first movement member 640 may transmit power from the drive member 620 to the locking device 70.

The door opening device 60 may further comprise a second movement member 690, which receives the movement force of the first movement member 640.

The second movement member 640 may transmit power from the drive member 620 to the locking device 70 in relative motion to the first movement member 690. The second movement member 690 may be coupled to the locking device 70.

In this embodiment, the second movement member 690 may move in a second direction that intersects with the first direction as the first movement member 640 moves in the first direction. For example, the second movement member 690 may be curvedly movable or rotationally movable, thereby allowing the locking device 70 to be rotated.

The second door 40 may be provided with a supporter 750 that rotatably supports the locking device 70. The supporter 750 may be a separate configuration from the case 610 or may be integrally formed with the case 610.

In this embodiment, the second movement member 690 may be integrally formed with or coupled to the locking device 70. If the second movement member 690 is integrally formed with the locking device 70, it may be understood that the door opening device 60 comprises only the first movement member 640.

The door opening device 60 may further comprise a door opening portion for automatically opening the second door 40. The first movement member 640 may transmit power from the drive member 620 to the door opening portion.

In this embodiment, in a locked state of the second door 40 and the first door 30, the second door 40 cannot be opened even if the door opening portion is actuated. In an unlocked state of the second door 40 and the first door 30, the second door 40 can be opened by the door opening portion.

In this embodiment, the time of transmission of a driving force to the locking device 70 and the time of transmission of a driving force to the door opening portion may be set differently, such that the door opening portion is operated after the locking device 70 is moved to an unlocked position.

That is, by operation of the actuating member 620, in the course of movement of the first movement member 640, the actuating force may be transferred firstly to the locking device 70 and thereafter the actuating force may be transferred to the door opening.

The door opening portion may comprise a pusher 670. The pusher 670 may protrude from the second door 40 to push the first door 30 upon actuation of the actuating portion 620.

The pusher 670 may protrude from the second door 40 in a rotational motion, for example. The pusher 670 may be connected to a pin 681 supported on the case 610. The pusher 670 may rotate with the pin 681 or may rotate with respect to the pin 681. The pin 681 may provide a center of rotation of the pusher 670. Alternatively, the center of rotation of the pusher 670 may be located on the pin 681.

The door opening portion may further comprise a first transmission portion 650 movable by the first movement member 640. The first transmission portion 650 may be located on one side of the first movement member 640. For example, the first transmission portion 650 may be located on a lower side of the first movement member 640. As the first transmission portion 650 and the first movement member 640 are arranged in an up-down direction, an increase in thickness of the second door 40 may be avoided.

The door opening portion may further comprise a second transmission member 660 movable by the first transmission member 650. At least a portion of the second transmission portion 660 may be positioned between the first transmission portion 650 and the first movement member 640, for example. By the arrangement of the first transmission portion 650 and the second transmission portion 660 and the first movement member 640, the increase in the thickness of the second door 40 may be prevented.

The pusher 670 may be actuated by the second transmission member 660. At least a portion of the pusher 670 may be positioned between the first movement member 640 and the second transmission portion 660.

If the first movement member 640, the pusher 670, the second transmission member 660, and the first transmission portion 650 are arranged in an up-down direction, for example, the door opening device 60 may be compact, and the increase in the thickness of the second door 40 may be avoided.

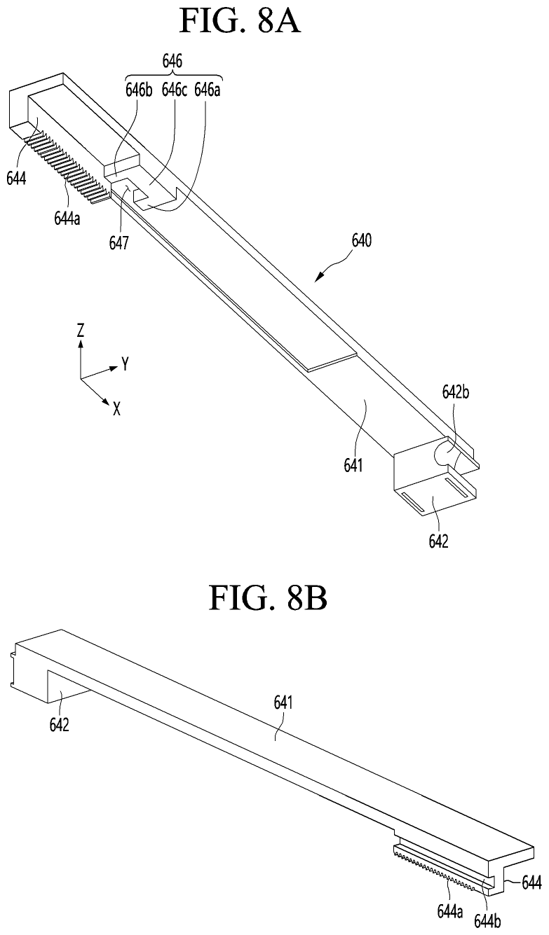

FIG. 8A is a perspective view of the first movement member according to one embodiment of the present invention from one side, and FIG. 8B is a perspective view of the first movement member according to one embodiment of the present invention from the other side.

Referring to FIG. 7, FIG. 8A, and FIG. 8B, the first movement member 640, according to an embodiment of the present disclosure, may include a body 641. The body 641 may be formed in a form of a thin plate, for example.

The first movement member 640 may further comprise a first extension 642 extending from the body 641. The first extension 642 may be in contact with the second movement member 690.

The first extension 642 may, for example, protrude from a top surface or bottom surface of the body 641. The first extension 642 may include a first contact surface 642a. The first contact surface 642a may include an inclined surface.

The first movement member 640 may be movable, for example, in an X-axis direction. The X-axis direction may be, for example, a downward direction of the second door 40. As used herein, the Y-axis direction may be an alignment direction of the first door 30 and the second door 40 or a front-to-rear direction of the second door 40.

The inclined plane may be inclined with the X-axis and Y-axis. For example, the inclined plane may be inclined in a direction that is closer to the first door 30 and further away from the second movement member 690. As the first movement member 640 is moved by the inclined plane, the second movement member 690 may be moved along the inclined plane, causing the locking device 70 to rotate.

The first extension 642 may further comprise a second contact surface 642b. The second contact surface 642b may extend from an end of the first contact surface 624a. The second contact surface 642b may be formed in a curved shape. The second contact surface 642b may form a space for receiving the second movement member 690. After the locking device 70 is moved to the unlocked position, the first movement member 640 may be further moved in the first direction with the second movement member 690 accommodated in the space.

The first movement member 640 may further comprise a rack portion 644 extending from the body 641. The rack portion 644 may, for example, protrude from a top surface or bottom surface of the body 641. The rack portion 644 may be spaced apart from the first extension 642 in the X-axis direction.

A gear 644a may be formed on a surface of the rack portion 644. For example, the gear 644a may be formed on a bottom surface of the rack portion 644. The gear 644a may engage with the driven gear 633.

The other surface of the rack portion 644 may be provided with a guide portion 644b for guiding movement of the first movement member 640. The guide portion 644b may interact with a guide portion provided on the case 610, for example. The guide portion 644b may comprise a rib in a protruding shape or a groove.

The first movement member 640 may further comprise a second extension 647. The second extension 646 may contact the first transmission portion 650 during the movement of the first movement member 640.

The second extension 646 may protrude from a top surface or bottom surface of the body 641, for example. The second extension 646 may be positioned closer to the rack portion 644 than the first extension 642.

A protruding length of the rack portion 644 may be different from the protruding length of the second extension 646.

The second extension 646 may include a first portion 646a. The first portion 646a may extend in the y-axis direction, for example.

The second elongate portion 646 may further include a second portion 646b spaced apart from the first portion 646a. The second portion 646c may extend in the y-axis direction.

The second extension 646 may further include a third portion 646c connecting the first portion 646a and the second portion 646b. The third portion 646c may extend in a direction intersecting the first portion 646a or the second portion 646b. The third portion 646c may extend in an x-axis direction, for example.

The second portion 646b may be positioned closer to the rack portion 644 than the first portion 646a.

The first portion 646a, second portion 646b, and third portion 646c may form a space 647. In the space 647, a portion of the first transmission portion 650 may be located.

The second portion 646b may be connected to the rack portion 644 or spaced apart from the rack portion 644.

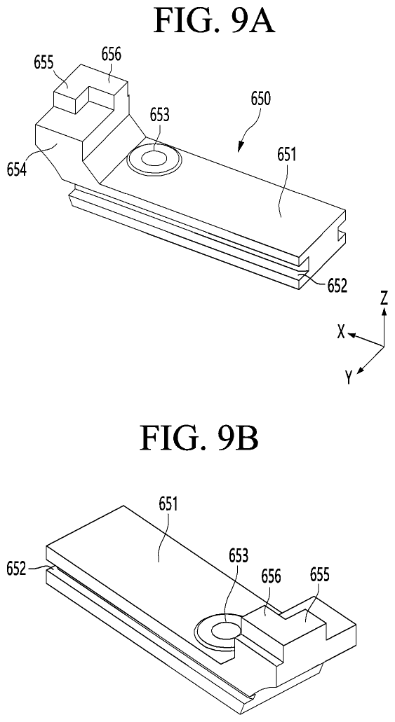

FIG. 9A is a perspective view of a first transmission portion according to one embodiment of the present invention from one side, and FIG. 9B is a perspective view of a first transmission portion according to one embodiment of the present invention from the other side.

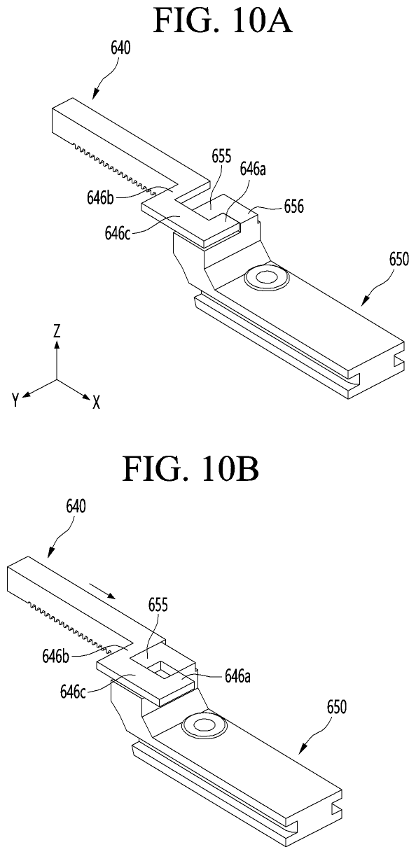

FIG. 10A is a drawing illustrating the position of the second extension of the first movement member and the contact protrusion of the first transmission portion in a first position of the first movement member, and FIG. 10B is a drawing illustrating a state in which the second portion of the first movement member is in contact with the contact protrusion of the first transmission portion during the opening process of the second door.

Referring to FIGS. 8 through 10B, the first transmission member 650 may include a body 651. A guide portion 652 may be formed on at least one side of the body 651.

The guide portion 652 may interact with a guide portion provided in the case 610, for example. The guide portion 652 may include ribs or grooves.

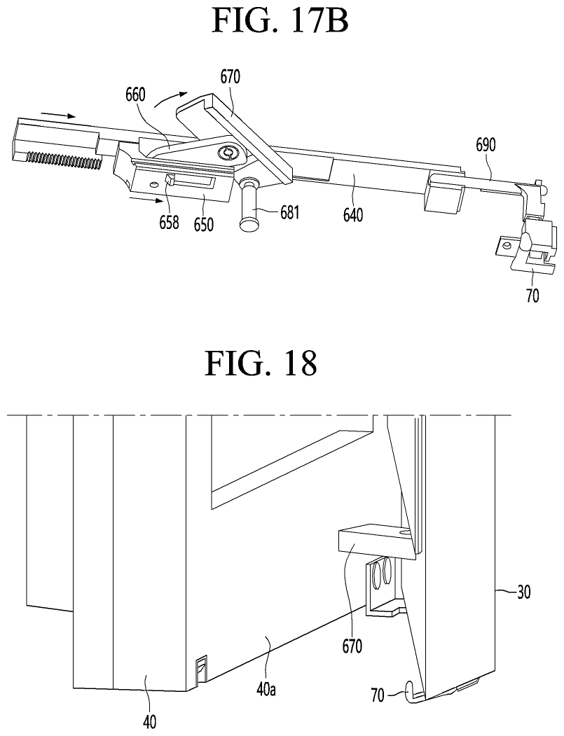

The guide portion 652 may be provided on a plurality of surfaces for stable movement of the first transmission portion 650. Although not limiting, the plurality of surfaces may be surfaces facing each other. Alternatively, the guide portion (see 658 in FIG. 17) may be provided on a surface that intersects with the plurality of faces. Alternatively, the guide portions 652, 658 may be provided on two intersecting faces.

The first transmission portion 650 may be rotatably connected to the second transmission portion 660, for example. The first transmission portion 650 may be provided with a connection hole 653 for connection with the second transmission portion 660.

The first transmission portion 650 may further comprise a contact portion 654 extending from the body 651. The contact portion 654 may be bent at the body 651. For example, the contact portion 654 may be bent upwardly at one end of the body 651.

The contact portion 654 may be in contact with the second extension 646. The contact portion 654 may include a contact protrusion 655 (or first part thereof). The contact protrusion 655 may be positioned in the space 647 formed by the second extension 646.

The contact protrusions 655 may extend in a Y-axis direction, for example. The contact portion 654 may further comprise a reinforcement portion 656 (or second part) extending in a direction intersecting the contact protrusions 655.

The contact protrusions 655 and the reinforcement portion 656 may be formed by a protrusion of a surface of the contact portion 654, or may be formed by a depression of a surface of the contact portion 654.

The contact protrusion 655 may be substantially in contact with the second extension 646. The reinforcement portion 656 may be connected to the contact protrusion 655 in terms of reinforcing the strength of the contact protrusion 655. The reinforcing portion 656 may be in contact with or spaced apart from the second extension 646. Accordingly, the reinforcement portion 656 may be repositioned or omitted.

The spacing distance between the first portion 646c and the second portion 646b of the first movement member 640, or the X-axis length of the space 647, may be greater than the width or X-axis length of the contact protrusion 655.

In a first position of the first movement member 640, the second portion 646b of the first movement member 640 may be spaced apart from the contact protrusion 655. The first portion 464a may be in contact with the contact protrusion 655.

In the process of movement of the first movement member 640 for opening of the second door 40, the second portion 646b may come into proximity with the contact protrusion 655.

Before the second portion 646b is in contact with the contact protrusion 655, no movement force of the first movement member 640 is transmitted to the contact protrusion 655. When the second portion 646b is in contact with the contact protrusion 655, the movement force of the first movement member 640 is transmitted to the contact protrusion 655 to allow the first transmission portion 650 to move.

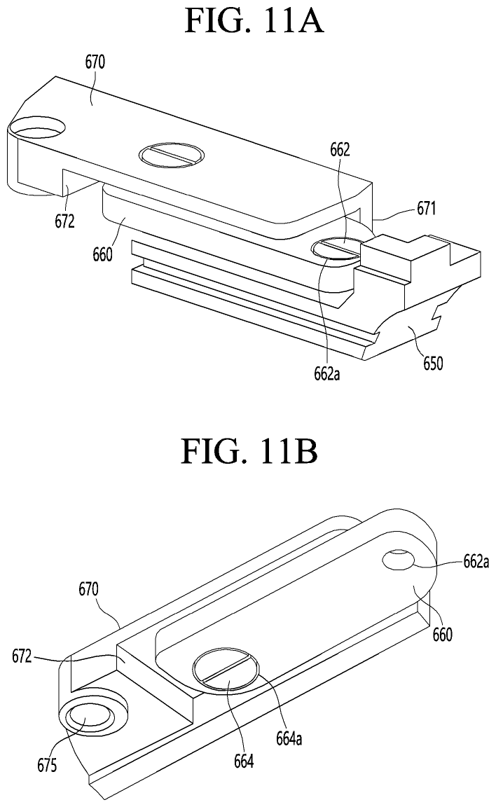

FIG. 11A is a side view of a door opening according to one embodiment of the present invention, and FIG. 11B is a perspective view showing a pusher and a second transmission member connected according to one embodiment of the present invention.

Referring to FIGS. 7 through 11B, the second transmission portion 660 may be rotatably connected to the first transmission portion 650 by, for example, a first connection 662.

The first connection 662 may be a pin that is in separate configuration from the first transmission portion 650 and the second transmission portion 662. The second transmission portion 660 may have a first connection hole 662a formed therein for the first connection 662 to be connected to. Alternatively, the first connection 662 may be formed integrally with the first transmission portion 650 or the second transmission portion 660.

The second transmission portion 660 may be connected to the body 651 at an upper side of the body 651 of the first transmission portion 650, for example.

The pusher 670 may be rotatably connected with the second transmission portion 660 by a second connection 664.

The second connection 664 may be a pin that is in separate configuration from the second transmission member 660 and the pusher 670. The second transmission portion 660 may have a second connection hole 664a formed therein for the second connection 664 to be connected to. The second connection hole 664a may be longitudinally spaced apart from the first connection hole 662a and the second transmission portion 660.

Alternatively, the second connection hole 664 may be integrally formed with the second transmission portion 660 or the pusher 670.

The pusher 670 may comprise a pressing surface 671 for pressing the first door 30 in the process of automatic opening of the second door 40.

The pusher 670 may further comprise a receiving portion 672 for receiving the second transmission portion 660. The receiving portion 672 may be formed, for example, as a depression in a first surface of the pusher 670.

In the first position of the first movement member 640, the pusher 670 (or door opener) may also be positioned in an initial position. In a second position of the first movement member 640, the pusher 670 (or door opening portion) may be positioned in a door open position.

At the initial position of the pusher 670, a portion of the second transmission member 660 may be received in the receiving portion 672, and the other portion may be positioned outside the receiving portion 672.

The area (or volume) of some of the portions of the second transmission portion 660 may be larger than the area (or volume) of the other portion of the second transmission portion 660. The other portion of the second transmission portion 660 may be connected to the first transmission portion 650 by the first connection 662.

Based on the closed state of the first door 30 and the second door 40, the receiving portion 672 may overlap the pressurized surface 671 in the Y-axis direction. Thus, the exposure of the second transmission portion 660 to the outside may be reduced in a state where the pressing surface 671 presses the first door 30.

The pusher 670 may further comprise a pin hole 675 that engages with a pin 681 supported on the case 610.

In an initial position of the pusher 670, the second connection hole 644a may be positioned between the pin hole 675 and the first connection hole 662a. Alternatively, in the initial position of the pusher 670, the second connection 664 may be positioned between the pin 681 and the first connection 662.

When the first transmission portion 650 is moved during the opening process of the second door 40, the first connection 662 and the second connection 664 may move horizontally. During the opening process of the second door 40, the horizontal movement of the pin 681 relative to the front of the second door 40 may be limited.

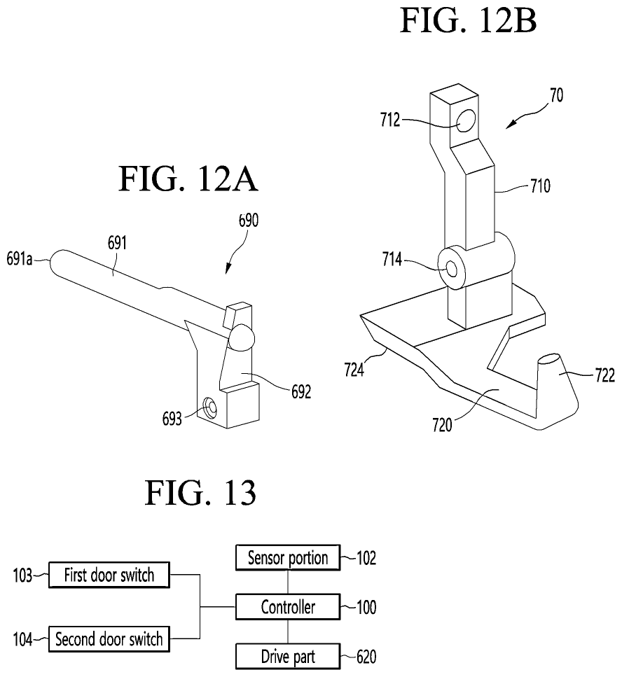

FIG. 12A is a perspective view of a second movement member according to one embodiment of the present invention, and FIG. 12B is a perspective view of a locking device according to one embodiment of the present invention.

Referring to FIGS. 7, 12A, and 12B, the second movement member 690 may be arranged in the X-axis direction of the first movement member 640, such that an increase in the thickness of the second door 40 may be prevented.

The second movement member 690 may comprise a movement bar 691. The movement bar 691 may be in contact with the first movement member 640. The movement bar 691 may include a contact end 691a. The contact end 691a may be in sequential contact with the first contact surface 642a and the second contact surface 642b.

The second movement member 690 may include a coupling portion 692 extending from the movement bar 691. The coupling portion 692 may, for example, extend downwardly from the movement bar 691. The coupling portion 692 may be engaged with the locking device 70.

The coupling portion 692 may include coupling hole 693 through which the coupling member is coupled.

The locking device 70 may include a first body 710. The first body 710 may be coupled to the coupling portion 692. The first body 710 may extend in an upward or downward direction, for example.

The locking device 70 may further comprise a second body 720 extending from the first body 710 in a direction intersecting the first body 710.

The first body 710 may have a hole 714 through which a shaft 730 is engaged to provide a center of rotation. The shaft 730 may be engaged in the hole 714 by passing through the supporter 750. Alternatively, the shaft 730 may be integrally formed with the first body 710. In either case, the locking device 70 may be rotatable about a center of rotation extending in a horizontal direction.

The second body 720 may be positioned below the first body 710, and may include a hook 722 which is hooked to the catching portion 310.

A portion of a lower surface of the second body 720 may be an operation surface 724 which is manipulated by a user. The manipulation surface 724 may be positioned on an opposite side of the hook 722 relative to the first body 710. For example, pressing the operating surface 724 upwardly may cause the locking device 70 to rotate in an unlocking direction.

In the following, the operation of the locking device 70 and the door opening device 60 will be described in detail.

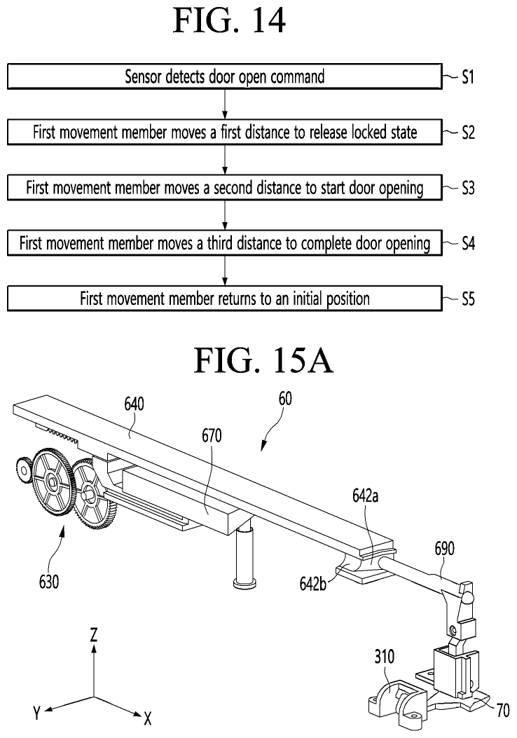

FIG. 13 is a block diagram of a control block of a refrigerator according to one embodiment of the present invention. FIG. 14 is a flow diagram illustrating the operation of the door opening device and the locking device step by step according to the travel distance of the first movement member.

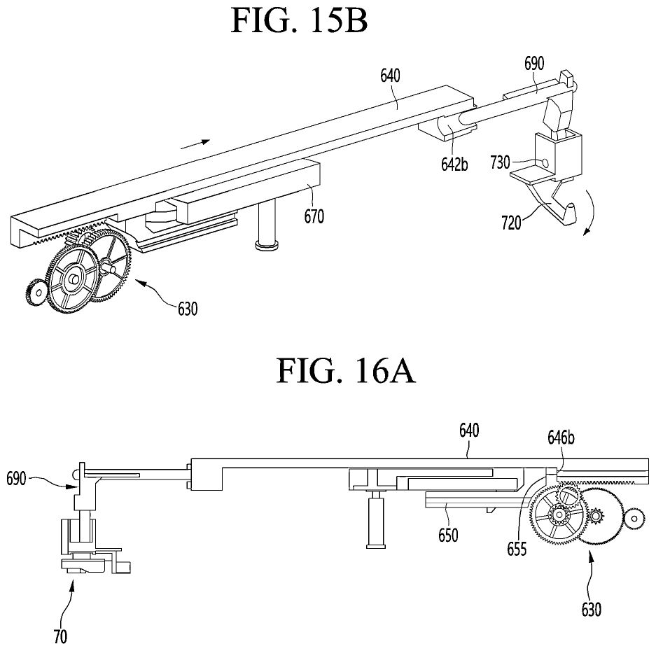

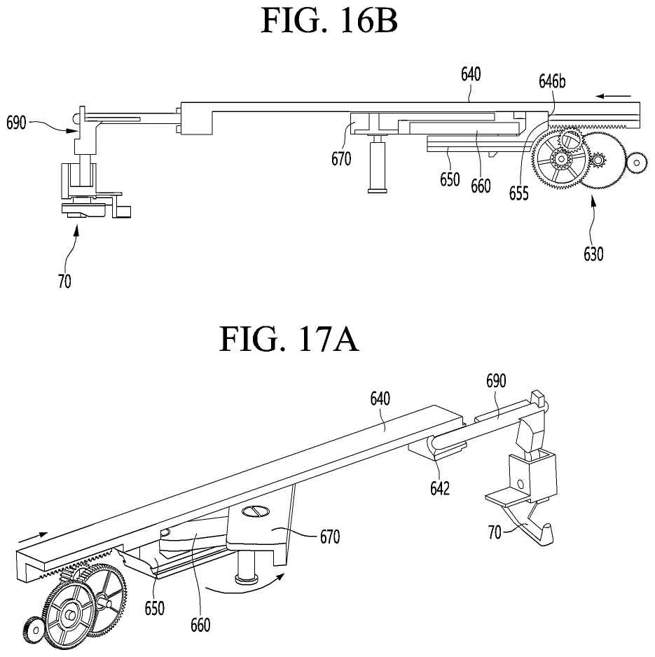

FIGS. 15A and 16A are diagrams illustrating the door opening device and locking device in a first position of the first movement member, FIGS. 15B and 16B are diagrams illustrating the door opening device and locking device when the first movement member has been moved a second distance, FIG. 17 is a diagram illustrating the door opening device and locking device with the first movement member moved to a second position, and FIG. 18 is a diagram illustrating a state in which the opening of the second door is completed.

Referring to FIGS. 4 through 18, the refrigerator of this embodiment may further include a controller 100. The controller 100 may be installed on or spaced apart from an object to be controlled. The controller 100 may be located inside or outside the object to be controlled.

For example, the control unit 100 may be provided on the cabinet 10 or may be provided on the refrigerator door 20.

The controller 100 may control the drive part 620. The controller 100 may be located outside the actuating part 620. The controller 100 may control the drive part 620 alone, or may control other configurations in the refrigerator other than the drive part 620.

### [Manual Opening of the Second Door]

As described above, even if no input of a door opening command is detected by the sensor portion 102, a user may operate the locking device 70 for manual opening of the second door 40.

In a state where the first movement member 640 is positioned in the first position, the locking device 70 is operable alone. Accordingly, the user may press the operation surface 724 of the locking device 70 in a first direction (e.g., an upward direction) to rotate the locking device 70 in an unlocking direction, thereby moving the locking device 70 from a locked position to an unlocked position. Thereby, the catching between the hook 722 of the locking device 70 and the catching wall 314 of the first door 30 may be released. In this state, the user may rotate the second door 40 to open the second door 40.

### [Automatic Opening of the Second Door].

When the first door 30 and the second door 40 are closed and the first door 30 and the second door 40 are in the locked state, a door opening command may be detected at the sensor portion 102 (S1). Then, the controller 100 may control the drive part 620 for automatic opening of the second door 40.

In the present embodiment, the actuation of the drive part 620 for opening the second door 40 may be performed while the first door 30 is closed. The opening or closing of the first door 30 may be detected by a first door switch 103. The first door switch 103 may be provided on the cabinet 10 or may be provided on the first door 30.

The operation of the drive part 620 for opening the second door 40 may be performed in a state where the second door 40 is in a closed state. The opening or closing of the second door 40 may be detected by the second door switch 104. The second door switch 104 may be provided on the first door 30 or may be provided on the second door 40.

The controller 100 may rotate the motor in one direction. When the motor is rotated in the one direction, the power from the drive unit 620 may be transmitted to the first movement member 640 via the transmission unit 630.

In a first position of the first movement member 640, the second portion 646b of the first movement member 640 may be spaced apart from the contact protrusion 655. In the process of movement of the first movement member 640 in the first direction for opening of the second door 40, the second portion 646b may become closer to the contact protrusion 655.

Before the second portion 646b is in contact with the contact protrusion 655, no movement force of the first movement member 640 is transmitted to the contact protrusion 655.

In the process of the first movement member 640 moving a first distance in the first direction from the first position, the first door 30 and the second door 40 may be unlocked (S2).

In one example, in the process of the first movement member 640 moving the first distance from the first position, the first contact surface 642a pushes the contact end 691a of the second movement member 690, causing the contact end 691a and the first contact surface 642a to slide relative to each other.

In the process of the contact end 691a slidingly moving with the first contact surface 642a, the second movement member 690 may be subjected to curvilinear motion, thereby rotating the locking device 70 to unlock the first door 30 and the second door 40.

With the first movement member 640 having moved the first distance from the first position, the contact end 691a may be positioned at the boundary of the first contact surface 642a and the second contact surface 642b, or may be in contact with the second contact surface 642b.

With the first movement member 640 moved the first distance from the first position, the second portion 646b may be spaced apart from the contact protrusion 655.

When the first movement member 640 is moved from the first position by a second distance greater than the first distance, opening of the second door 40 begins.

In one example, when the first movement member 640 is moved from the first position by the second distance, the second portion 646b comes into contact with the contact protrusion 655. In this state, when the first movement member 640 moves further in the first direction, the first transmission portion 650 moves together with the first movement member 640.

As the first transmission member 650 moves in the first direction, the second transmission member 660 may be rotated, and in conjunction therewith, the pusher 670 may be rotated.

In the process of the first transmission portion 650 moving, the distance between the first connection 662 and the pin 681 may decrease. On the other hand, the distance between the first connection 662 and the second connection 664 and the distance between the second connection 664 and the pin 681 may remain constant while the first transmission member 650 moves.

In one example, the pusher 610 is positioned in an initial position until the first movement member 640 is moved from the first position by the second distance. When the first movement member 640 is moved from the first position by a third distance greater than the second distance, the opening of the second door 40 is completed (S4).

When the first movement member 640 is moved from the first position by the third distance, the pusher 670 is positioned in the door open position.

After the opening of the second door 40 is completed, the motor may be rotated in the other direction to allow the first movement member 640 to return to the first position, which is the initial position (S5).

With the first movement member 640 moved to the second position, the first portion 646a may be spaced apart from the contact protrusion 655. In the process of the first movement member 640 moving in a third direction opposite to the first direction, the first portion 646a may come into contact with the contact protrusion 655. After the first portion 646a is in contact with the contact protrusions 655, the first transmission portion 650 also moves in the third direction when the first movement member 640 moves in the third direction. The third directional movement of the first transfer member 650 causes the pusher 670 to move to the initial position.

According to one embodiment, in a door comprising a first door and a second door, it is advantageous to enable automatic opening of a second door positioned outside the first door.

According to one embodiment, in the door comprising the first door and the second door, it is advantageous that the second door positioned outside the first door is manually openable, depending on the needs of the user.

In one embodiment, the coupling state of the first door and the second door is maintained when the first door is opened, so that unintentional opening of the second door may be prevented.

According to one embodiment, the arrangement of the drive unit, the transmission unit, and the movement member has the advantage of allowing installation and operation of the door opening device within a limited thickness range of the second door.

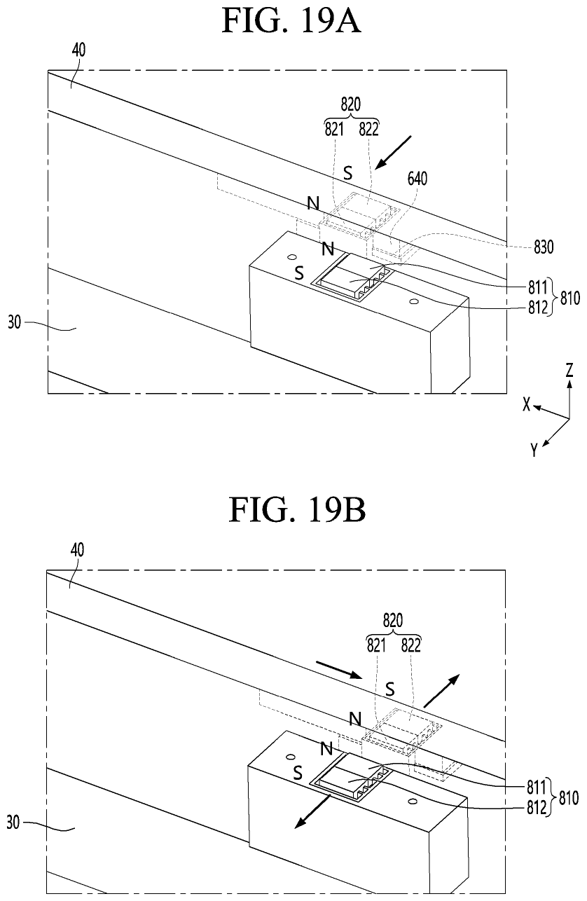

FIG. 19A is a drawing showing a door opening device and a locking device in a first position of the first movement member according to another embodiment of the present invention, and FIG. 19B is a drawing showing a door opening device and a locking device in a second position of the first movement member.

The present embodiment is identical in other respects to the previous embodiments, with differences in the door opening portion. Therefore, only the characteristic parts of the present embodiment will be described below.

In FIGS. 19A and 19B, the lock is omitted.

Referring to FIGS. 19A and 19B, the door opening portion of the present embodiment may include a first magnetic unit 810 provided on the first door 30 and a second magnetic unit 820 provided on the second door 40.

The first magnetic unit 810 may be fixed in position in the first door 30. The first magnetic unit 810 may include a first magnet 811 having a first pole, and a second magnet 812 having a second pole that is an opposite pole to the first pole. The first pole may be an N pole and the second pole may be an S pole, or vice versa.

The first magnet 811 and the second magnet 812 may be formed integrally or separately.

The second magnetic unit 820 may be movably mounted on the second door 40. For example, the second magnetic unit 820 may be movable together with the first movement member 640. The second magnetic unit 820 may be installed directly on the first movement member 640 or may be installed on the first movement member 640 while supported on a bracket 830.

The second magnetic unit 820 may include a third magnet 821 having a first pole, and a fourth magnet 822 having a second pole.

The third magnet 821 and the fourth magnet 822 may be formed integrally or separately.

The third magnet 821 may have the same polarity as the first magnet 811. The fourth magnet 822 may have the same polarity as the second magnet 812.

In the first door 30, the first magnet 811 and the second magnet 812 may be arranged in the Y-axis direction. In the second door 40, the third magnet 821 and the fourth magnet 822 may be arranged in the Y-axis direction.

Alternatively, in the first door 30, the first magnet 811 and the second magnet 812 may be arranged in the X-axis direction. It is also possible that in the second door 40, the third magnet 821 and the second magnet 822 are arranged in the X-axis direction. In this case, the fourth magnet 822 may be positioned adjacent to the first magnet 811 when the second door 40 is closed. For opening the second door 40, the fourth magnet 822 may be moved in a direction that brings the fourth magnet 822 closer to the second magnet 812. For opening the second door 40, the third magnet 821 may be moved in a direction that brings the first magnet 811 closer to the second magnet 812.

Meanwhile, in the closed state of the second door 40 and in the locked position of the locking device, the first magnet 811 and the third magnet 821 may not overlap in the y-axis direction.

In the closed state of the second door 40, the second door 40 may be held closed by an attractive force between the first magnetic unit 810 and the second magnetic unit 820.

When the first movement member 640 is moved in a first direction to open the second door 40, the third magnet 821 may be moved in a direction that brings the first magnet 811 closer to the second magnetic unit 810. As the first movement member 640 moves, the locking device 70 may move from a locked position to an unlocked position.

When the first movement member 640 moves in the first direction, the amount of overlap of the first magnet 811 and the third magnet 821 in the Y-axis direction may be increased. After the locking device 70 has been moved to the unlocked position, further movement of the first movement member 640 may cause a pretension force to act between the first magnet 811 and the third magnet 821. The pretension force may act as a force for automatic opening of the second door 40.

In the present embodiment, the door opening is prevented from being exposed to the outside of the door, which has the advantage of providing a cleaner appearance of the door.

Furthermore, in the present embodiment, the second door 40 can be automatically opened by utilizing the gripping force between the magnets, which has the advantage of simplifying the structure of the door opening device.

What is claimed is:

1. A refrigerator, comprising:
a cabinet having a storage space;
a first door configured to open or close the storage space and having an opening;
a second door configured to open or close the opening and rotatable with respect to the first door;
a locking device for causing the first door and the second door to be in a locked or unlocked state in a state where the second door is closed; and
a door opening device configured to automatically open the second door,
wherein when the door opening device is actuated, the door opening device opens the second door after moving the locking device to an unlocked position.

2. The refrigerator of claim 1, wherein, in a non-operational state of the door opening device, the locking device is manually movable to the unlocked position.

3. The refrigerator of claim 1, wherein the door opening device and the locking device are provided on the second door.

4. The refrigerator of claim 1, wherein the door opening device comprises:
a drive part;
a first movement member configured to receive power from the drive part; and
a door opening portion configured to receive a movement force of the first movement member.

5. The refrigerator of claim 4, wherein when the drive part is actuated to open the second door, the first movement member moves in a first direction, and
wherein in a process of the first movement member moving in the first direction, the first movement member actuates the locking device.

6. The refrigerator of claim 5, further comprising a second movement member configured to transmit the movement force of the first movement member to the locking device,
wherein, upon movement of the first movement member in the first direction, the second movement member curvilinearly moves in a second direction intersecting the first direction.

7. The refrigerator of claim 5, wherein the locking device is actuated when the first movement member is moved a first distance which is an initial position,
wherein the door opening portion is actuated when the first movement member is moved a second distance from the first position, and
wherein the door opening portion is moved to a door open position when the first movement member is moved a third distance from the first position.

8. The refrigerator of claim 4, wherein the door opening portion comprises a pusher operable to receive a movement force of the first movement member to press the first door.

9. The refrigerator of claim 8, wherein the door opening portion further comprises:
a first transmission portion movable by the first movement member; and
a second transmission portion rotatably connected to the first transmission portion,
wherein the pusher is rotatably connected to the second transmission portion.

10. The refrigerator of claim 9, wherein the first transmission portion is linearly movable, and
wherein the second transmission portion and the pusher are rotationally movable.

11. The refrigerator of claim 9, wherein the locking device is actuated when the first movement member is moved a first distance from a first position which is an initial position, and
wherein, when the first movement member is moved from the first position to a second distance or more, a movement force of the first movement member is transmitted to the first transmission portion.

12. The refrigerator of claim 4, wherein the door opening portion further comprises:
a first magnetic unit provided on the first door; and
a second magnetic unit provided on the second door,
wherein the second magnetic unit is movable together with the first movement member.

13. The refrigerator of claim 12, wherein the first magnetic unit comprises:
a first magnet having a first pole; and
a second magnet having a second pole opposite the first pole,
wherein the second magnetic unit comprises:
a third magnet having the first pole; and
a fourth magnet having the second pole, and
wherein the third magnet is moved in a direction closer to the first magnet for opening the second door.

14. The refrigerator of claim 13, wherein, in a state where the second door is closed, the first magnet and the second magnet are arranged in a Y-axis direction, which is the direction of arrangement of the first door and the second door,
wherein the third magnet and the fourth magnet are arranged in the Y-axis direction,
wherein the third magnet is positioned closer to the first magnet than to the fourth magnet.

15. The refrigerator of claim 13, wherein, in a state wherein the second door is closed, the first magnet and the second magnet are arranged in an X-axis direction intersecting with the direction of arrangement of the first door and the second door,
wherein the third magnet and the fourth magnet are arranged in the X-axis direction, and
wherein the fourth magnet is positioned closer to the first magnet than to the third magnet.

16. The refrigerator of claim 1, further comprising:
a sensor portion configured to detect input of an opening command of the second door; and
a controller configured to control the door opening device,
wherein the controller controls the door opening device to cause the first door and the second door to be in an unlocked state, and the second door to be opened when input of an opening command of the second door is detected by the sensor portion.

17. A refrigerator, comprising:
a cabinet having a storage space; and
a door configured to open or close at least a portion of the storage space,
wherein the door includes:
a first door rotatably connected to the cabinet;
a second door rotatable with respect to the first door;
a locking device that causes the first door and the second door to be in a locked or unlocked state when the second door is closed; and
a door opening device configured to automatically open the second door,
wherein, in a locked position of the locking device, the locking device is manually operable by a user and automatically operable by the door opening device.

18. The refrigerator of claim 17, wherein the storage space comprises a refrigeration chamber and a freezer chamber positioned below the refrigeration chamber,
wherein the first door opens or closes the refrigeration chamber, and
wherein the door opening device and the locking device is located below the second door.

19. The refrigerator of claim 17, wherein the door opening device comprises a door opening portion, and
wherein an operation time of the locking device is differently set from an operation time of the door opening portion.

20. The refrigerator of claim 19, wherein the door opening device comprises:
a drive part; and
a first movement member configured to receive power from the drive part,
wherein the door opening portion is connected to the first movement member,
wherein, when the drive part is actuated, the first movement member operates the door opening portion after the locking device is moved by the first movement member to an unlocked position.
